(19) United States
(12) Patent Application Publication
(10) Pub. No.: US 2016/0031384 A1
(43) Pub. Date: Feb. 4, 2016

(54) MOTOR VEHICLE WITH A STORAGE BAG FOR A BICYCLE

(71) Applicant: GM GLOBAL TECHNOLOGY OPERATIONS LLC, Detroit, MI (US)

(72) Inventors: Max LIEBERKNECHT, Wiesbaden (DE); Daniel LAUTENSCHLAGER, Klein-Winternheim (DE); Kevin-Marc SCHAD, Griesheim (DE)

(73) Assignee: GM GLOBAL TECHNOLOGY OPERATIONS LLC, Detroit, MI (US)

(21) Appl. No.: 14/816,553

(22) Filed: Aug. 3, 2015

(30) Foreign Application Priority Data
Aug. 2, 2014 (DE) 102014011588.7

(51) Int. Cl. B60R 11/00; B60R 5/04

(52) U.S. Cl. CPC B60R 11/00; B60R 5/04; B60R 2011/0003

(57) ABSTRACT

A storage bag for a motor vehicle is disclosed for stowing a bicycle inside an accommodation space bounded by the storage bag within the vehicle. The storage bag includes a bag with an opening for introducing and removing a bicycle through the opening, and at least one fastening device for attaching the bag to the motor vehicle.

### CROSS-REFERENCE TO RELATED APPLICATION

This application claims priority to German Patent Application No. 102014011588.7, filed. Aug. 2, 2014, which is incorporated herein by reference in its entirety.

### TECHNICAL FIELD

This application pertains to a bicycle storage bag configured for use with a motor vehicle and the motor vehicle having a storage bag for a bicycle.

### BACKGROUND

Motor vehicles with a drive motor exhibit seats for accommodating passengers of the motor vehicle. A trunk for holding cargo is provided behind the rear seats of the motor vehicle, in particular in station wagons with a tailgate. A bicycle is generally transported by the motor vehicle either on top of the roof outside of the motor vehicle in a special roof luggage rack, at the tail end area of the motor vehicle with a trailer hitch and a mounting fixture for bicycles fastened thereto, or by keeping or storing the bicycle in the trunk of the motor vehicle, meaning inside of the motor vehicle.

The advantage to storing or keeping the bicycle side the trunk is that the bicycle is not exposed to environmental influences, for example rain or dust, while on the other hand the motor vehicle aerodynamics are not impaired by the bicycle being secured to the outside of the motor vehicle. However, the danger to keeping the bicycle inside the trunk is that the bicycle will soil and/or scratch the trunk or parts of the motor vehicle bordering the trunk, for example a trunk floor, side panels or rear seats. This is especially disadvantageous, since it does permanent damage to the motor vehicle.

### SUMMARY

In accordance with the present disclosure provides a storage bag and a motor vehicle in which a bicycle can be safely and reliably arranged inside a trunk without the bicycle soiling or scratching the trunk. The storage bag keeps the bicycle inside an accommodation space bounded by the storage bag so that the storage bag with the bicycle can be stowed inside a trunk of the motor vehicle. The storage bag includes a bag with an opening for introducing and removing a bicycle through the opening, and at least one fastening device for attaching the bag to the motor vehicle. As an accessory for the motor vehicle, the storage bag makes it possible to situate the bicycle inside an accommodation space bounded by the storage bag. As a result, the bicycle does not lie directly on parts of the motor vehicle that border the trunk. For example, the bicycle thus does not rest directly on a trunk floor, a side panel on the trunk, or a rear seat, in particular the back part of a rear seat, or the back part of a front seat. Thus, parts of the motor vehicle bordering the trunk can be prevented from becoming damaged or soiled. The fastening devices make it possible to safely and reliably attach the storage bag to the motor vehicle with fastening devices, so that the accommodation space is already fully deployed and available before the bicycle is introduced into the accommodation space.

The fastening devices may be configured in various forms. For example, the storage bag may include at least one rear fastening device formed at a rear end area in the vicinity of the opening for attaching the bag to the motor vehicle or the storage bag may include at least one front fastening device formed at a front end area for attaching the bag to the motor vehicle. Alternately, two rear fastening devices and a front fastening device may be provided on the storage bag. It is preferred that the storage hag encompass at least one lower rear fastening device, preferably two lower rear fastening devices, at least one upper rear fastening device, preferably two upper rear fastening devices, at least one upper front fastening device, preferably two upper front fastening devices, and at least one lower front fastening device, preferably two lower front fastening devices. The storage device may further include at least one lower central fastening device, preferably two lower central fastening devices.

In a supplementary embodiment, the two rear fastening devices are formed on the bag at two opposing rear end areas in the vicinity of the opening. The two rear fastening devices are used to already have the opening be present essentially in a completely deployed state before the bicycle is introduced into the storage bag, as a result of which the bicycle can be smoothly introduced into the accommodation space. The front fastening device tensions the bag between the rear and front fastening devices, so that the bag or accommodation space already includes the entire length for accommodating the bicycle in the accommodation space.

In an additional embodiment, the fastening devices each encompass a preferably longitudinally adjustable or elastic band or a string. The longitudinally adjustable or elastic band can be used to adjustably attach the bag to different motor vehicles with trunks of varying size in an appropriate manner.

It is best that the fastening devices each encompass a fixing means or fastener, e.g., a hook or a hook and loop (e.g. Velcro®) fastener or suction cup or pushbutton or a magnet or an adhesive tape or a spring hook or a combination of these fastening devices, to fix the storage bag on the motor vehicle. In a fastening device taking the form of a suction cup, for example, the fastening device can be attached to a windowpane of the tailgate or some other smooth surface in the motor vehicle through suction. In an additional embodiment, the fastener is provided at an end of the band or string.

In a further embodiment, the bag is at least partially, and preferably completely made out of a nontransparent or opaque, flexible or bendable thin material. For example, the bag may be at least partially, and preferably completely, made out of a plastic, a PVC or polyester material or a fabric made out of a linen, cotton, or leather, felt or mesh material. The bag may also consist of a combination of these materials. Due to the nontransparent or opaque properties of the bag, the fact that a bicycle is being kept inside the bag and in the trunk is not visible from outside of the motor vehicle. In particular in the case of expensive bicycles, this can provide additional protection against theft, because the expensive bicycle is optically not visible from outside. The material of the bag is here preferably also liquid tight, so that any wetness or liquid adhering to the bicycle also does not get into the trunk.

In a supplementary variant, the bag includes an interior to border the accommodation space for the bicycle, and an exterior. In an additional embodiment, the exterior includes a rough surface, or an anti-slip coating and the interior includes a smooth surface. The smooth surface on the interior allows the bicycle to easily be introduced, in particular pushed, into the storage bag, so that only slight friction forces arise between the bicycle and interior of the bag as the bicycle slides. The rough surface on the exterior permits a high friction between the parts on the motor vehicle that border the trunk and the rough surface of the exterior. This additionally secures the storage bag to the motor vehicle. When the storage bag is folded together, for example so that it lies on the trunk floor in two layers one atop the other, the rough surface ensures that a greater friction arises on the rough surface of the exterior of the bag for cargo between the cargo lying against the exterior of the storage bag, so that the cargo is better secured inside the trunk.

The length of the bag is preferably greater than 1.5 m, 1.8 m or 2 m and/or the diameter of the bag is greater than 0.5 m, 0.7 m or 1 m. This makes it possible to completely store a commercially available bicycle inside the accommodation space bounded by the bag.

In a supplementary variant, the bag includes an additional opening, wherein part of the bag on the additional opening can be removed and/or swiveled relative to the remaining bag, preferably wherein the part with a bag zipper or bag a hook and loop (e.g. Velcro®) fastener is or can be detachably fastened to the remaining bag. Part of the bag can be removed from the remaining bag, so that an additional opening can be optionally and temporarily created in the area where the part has been removed. Alternatively, the bag zipper or bag a hook and loop (e.g. Velcro®) fastener between the part and remaining bag is only partially formed, e.g., U-shaped, so that the part can be swiveled away from the remaining bag like a window, since the bag between the remaining bag and part on the section without a bag zipper or bag a hook and loop (e.g. Velcro®) fastener acts as a film hinge. In the case of heavier bicycles, for example, it is easier to introduce the bicycle into the accommodation space if the end area of the bicycle already located partially in the accommodation space can also be accessed from outside via the additional opening, e.g., via a rear side door, so that the bicycle can more readily be introduced into the accommodation space. After the bicycle has been completely introduced into the accommodation space, the part can again be detachably secured to the remaining bag, so that the entire bag continues to remain nontransparent or opaque if the bag with the removable part has a nontransparent or opaque design.

In a supplementary embodiment, the storage bag has at least one of an upper elongation on the upper rear end area of the bag and a lower elongation on the lower rear end area of the bag. The upper elongation serves as a privacy shield with the tailgate closed, and the lower elongation prevents mechanical damage, in particular scratches, to the motor vehicle while loading and unloading the bicycle, and is used to divert excess water.

A motor vehicle according to the present disclosure includes a body, a drive motor, in particular an internal combustion engine and/or an electric engine, and a trunk having a storage bag as described in the present disclosure. In a supplementary variant, the storage bag is situated inside the vehicle, for example, in the trunk, attached to the front seat or a tailgate with an eyelet by means of the at least one fastening device. In a supplementary variant, the back parts of the back side are folded, so that the storage bag lies partially on the folded back part.

### BRIEF DESCRIPTION OF THE DRAWINGS

The present disclosure will hereinafter be described in conjunction with the following drawing figures, wherein like numerals denote like elements.

FIG. 1 is a side view of a motor vehicle with a storage bag inside the trunk;

FIG. 2 is a perspective view of a fastening device in a first exemplary embodiment of the storage bag according to FIG. 1;

FIG. 3 is a perspective view of the fastening device in a second exemplary embodiment of the storage bag according to FIG. 1;

FIG. 4 is a perspective view of the fastening device in a third exemplary embodiment of the storage bag according to FIG. 1;

FIG. 5 is a perspective view of the fastening device in a fourth exemplary embodiment of the storage bag according to FIG. 1;

FIG. 6 is a side view of the motor vehicle with the storage bag in a folded state inside the trunk; and

FIG. 7 is a side view of a bicycle.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

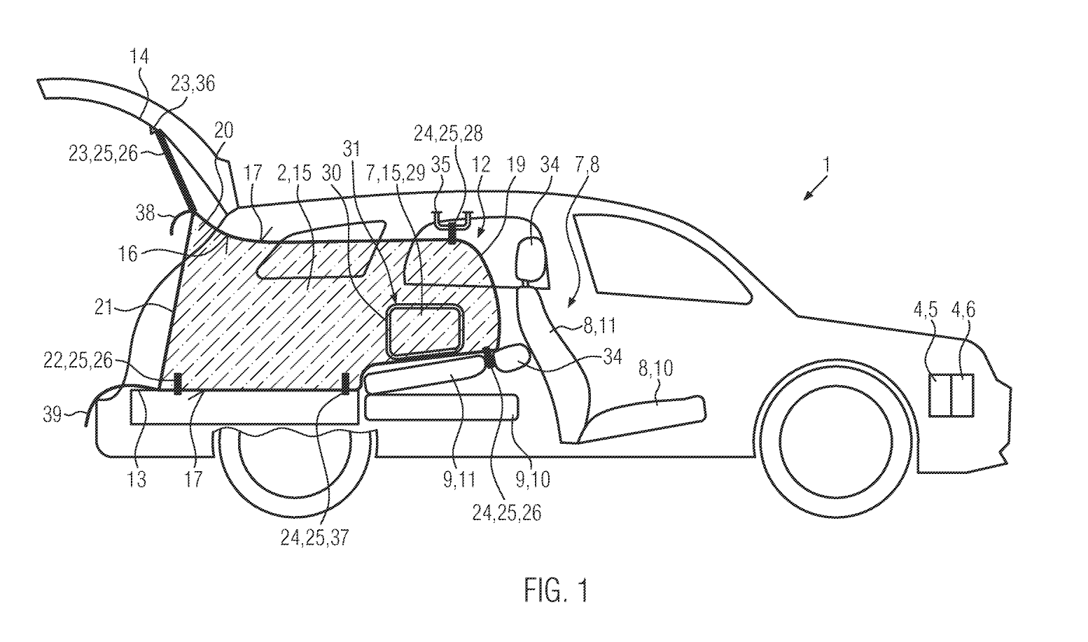

A motor vehicle 1 includes a body 3 made out of steel and a powertrain 4, here illustrated as having an electric motor 5 and an internal combustion engine 6. The body 3 envelopes a passenger compartment, and seats 7 are arranged inside the passenger compartment for accommodating passengers or individuals. The motor vehicle 1 here includes two front seats 8 and three rear seats 9. The rear seats 9 are here combined into a rear seat bench. The seats 7 each encompass a seat part 10 and a back part 11. The back part 11 of the rear seats 9 can be swiveled around a pivot axis, so that a trunk 12 includes a significantly larger volume with the back parts 11 of the rear seats 9 swiveled (FIG. 1) than with the back parts 11 not swiveled.

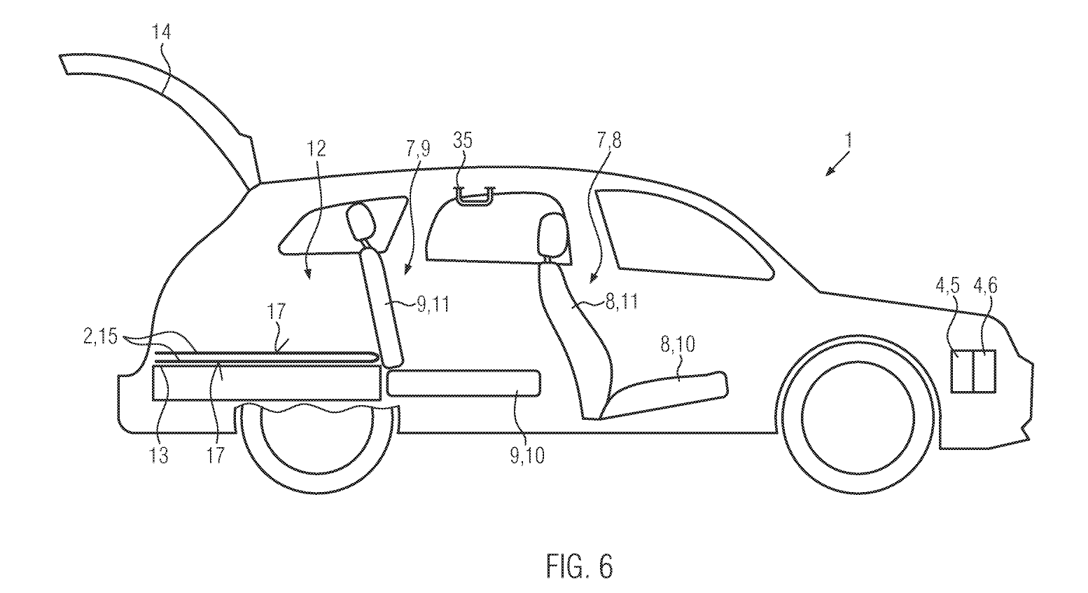

The trunk 12 is used to accommodate cargo, and is bordered from below by a trunk floor 13, and from the sides by lateral panels of the body 3. The trunk 12 is bordered from the back by a tailgate 14 with the tailgate (not shown) in the closed state, and from the front either by the back parts 11 of the rear seats 9 in a non-swiveled state (FIG. 6) or by the back parts 11 of the front seats 9 (FIG. 1).

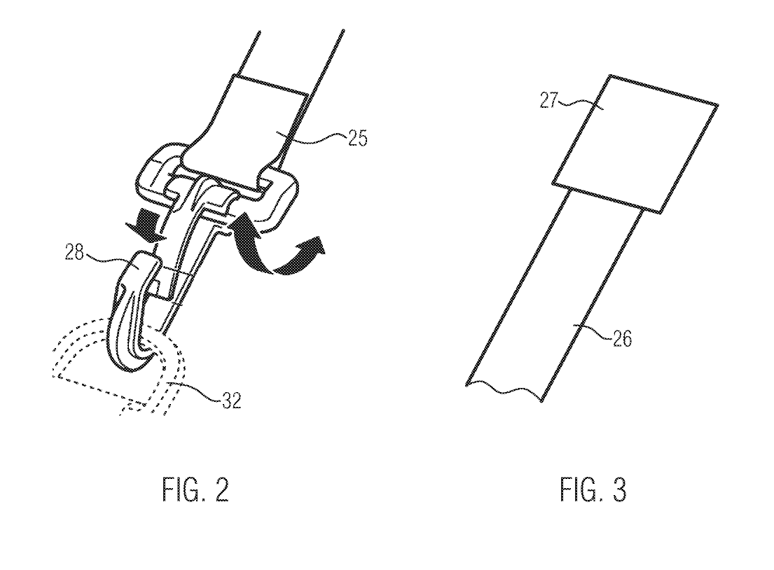

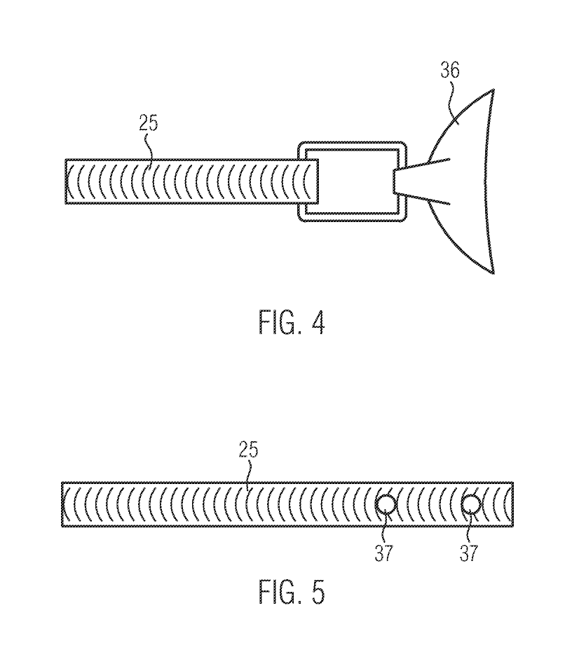

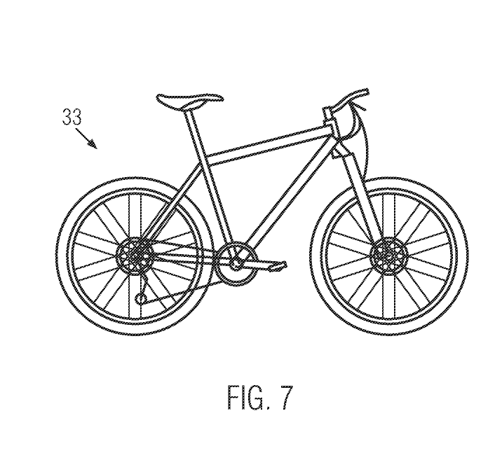

Located inside the trunk 12 is a storage bag 2 with a bag 15 and fastening devices 22, 23, 24. The bag 15 includes an interior 16 and exterior 17. The interior 16 defines an accommodation space 18 for keeping and storing a bicycle 33 (FIG. 7) inside the accommodation space 18. The bag 15 may include a plastic film, which is nontransparent or opaque, and further also liquid tight. At a rear end area 20 of the bag 15, the latter includes an opening 21 for introducing and removing the bicycle 33 into and from the accommodation space 118. The front end area 19 of the bag 15 is attached by means of a front lower fastening device 24 to the folded or swiveled back part 11 of the rear seat 9, i.e., to a fixing rod between the back part 11 and a headrest 34 on the back part 11. For example, the front fastening device 24 is designed as a band 25 or string 26 with a hook and loop (e.g. Velcro®) fastener 27, and the band 25 or string 26 (FIG. 3) with the hook and loop (e.g. Velcro®) fastener 27 is wound around fixing rods for the headrest 34 on the back part 11 of the rear seat 9, forming a loop (not shown), so that the front lower end area 19 is thereby attached to the rear seat 9. A lower fastening device 22 as depicted on FIG. 2 is provided in the rear end area 20 of the bag 15. The lower fastening device 22 includes a longitudinally adjustable band 25, and the end area of the band 25 has secured to it a hook 28, which is hooked into an eyelet 32 at the rear end area of the trunk 12. In the front upper end area 19, the bag 15 is attached by means of a front fastening device 24 as a longitudinally adjustable band 25 with a hook 28 to a handle 35 in the area of the roof liner above the rear doors. Two lower rear fastening devices 22 can here also be provided in the rear lower end area 20 of the bag 15. An upper rear fastening device 23 is provided on the upper rear end area 20 of the bag 15 opposite the lower rear fastening device 22. The upper rear fastening device 23 includes a band 25 as an elastic band, and the end of the elastic band 25 is detachably secured by way of a suction cup 36 (FIG. 4) to a windowpane of the tailgate 14. At a lower central area of the bag 15, the bag 15 is suspended from an eyelet 32 at the front end area of the trunk 12 by means of a longitudinally adjustable band 25 with two pushbuttons 37. To this end, the two pushbuttons 37 (FIG. 5) are positively and/or non-positively joined together in a detachable manner, so that the band 25 between the two pushbuttons 37 forms a loop, and the loop is suspended from the eyelet 32 (not shown). In order to detach the loop from the eyelet 32, the connection between the two pushbuttons 37 has to be eliminated, so that no loop is present, and the band 25 can be removed from the eyelet 32. The fastening devices 22, 23, 24 are preferably each provided in twos on either side of the motor vehicle 1, so as to hold the bag 15 on either side in a transverse direction.

The bag 15 may include two parts. A smaller part 29 of the bag 15 made out of the nontransparent plastic film is detachably secured to the remaining part of the bag 15 by means of a bag zipper or a bag hook and loop (e.g. Velcro®) fastener indicated at 30. By opening the bag zipper 30 or the bag hook and loop (e.g. Velcro®) fastener 30, the smaller part 29 can be removed from the remaining bag 15, thereby creating an additional opening 31 on the bag 15, and making the additional opening 31 accessible from outside with the side door open. When introducing the bicycle 33 into the accommodation space 18, i.e., when loading the bicycle 33 into the motor vehicle 1, forces can thus be manually exerted on the bicycle 33 not just in the area of the rear end area 20, but also through the additional opening 31, and therefore on the part of the bicycle 33 that is introduced into the opening first. This holds true conversely when unloading the bicycle 33 from the motor vehicle 1, i.e., when taking the bicycle 33 out of the accommodation space 18 and through the opening 21 with the tailgate 14 open. After the vehicle 1 has been loaded with the bicycle 33, the part 29 is again attached to the remaining part of the bag 15, so that the entire bag 15 thereby becomes nontransparent. The upper rear fastening device 23 is further attached to the lower end area of the windowpane of the tailgate 114, thereby blocking the view through the opening 21 from outside with the tailgate 14 closed (not shown), so that individuals outside of the motor vehicle 1 advantageously cannot see what kind of object is located inside the accommodation space 18 even when the bicycle 33 is stowed inside the accommodation space 18, and hence in the trunk 12. In addition, an upper elongation 38 is provided at the upper rear end area of the bag 15. The upper rear fastening device 23 is attached between the elongation 38 and bag 15. The function of the elongation 38 is to additionally block the view from outside the motor vehicle 1 through the windowpane of the tailgate 14 into the accommodation space 18 with the bicycle 33 when the tailgate 14 is closed. The elongation 38 includes an extension in the longitudinal direction of the motor vehicle 1 that exceeds 1 cm, 5 cm or 10 cm, with the extension in the longitudinal direction of the motor vehicle preferably being smaller than 50 cm, 40 cm or 30 cm. A lower elongation 39 similar to the upper elongation 38 is provided at the lower rear end area of the bag 15. The extension of the lower elongation 39 corresponds to the extension of the upper elongation 38. The upper and lower elongations 38, 39 are not present on the sides at the rear end on the bag 15. The lower elongation 39 lies on the bumper and the section of the motor vehicle 1 up to the lower rear end area of the bag 15 with the tailgate open 14, so that the elongation 39 can also be present up to a rear end area of the trunk floor 13. The function of the elongation 39 is to prevent mechanical damages, in particular scratches, to the section of the motor vehicle covered by the lower elongation 39, e.g., the bumper. Excess water in the bag 15 can be diverted by the elongation 39 into the environment, so that the excess water on the bicycle 33 does not stay in the bag 15. Before closing the tailgate 14, the elongation 39 is folded into the accommodation space 18, and lies below on the interior 16 of the bag 15.

The interior 16 of the bag 15 includes a smooth surface, and the exterior 17 includes a rough surface or anti-slip coating. The smooth surface of the interior 16 significantly reduces friction between the bicycle 33 and interior 16 of the bag 15 when the bicycle 33 comes into contact with the interior 16. If the storage bag 2 is not needed for storing the bicycle 33, the back parts 11 of the rear seats 9 are again folded, and the seat parts 10 are again situated. This significantly reduces the volume of the trunk 12 in the illustration on FIG. 4 by comparison to the illustration on FIG. 1. The exterior 17 includes a rough surface in the form of an anti-slip coating only on the exterior 17 situated below on FIG. 1, i.e., on the section of the exterior 17 that is also present in the trunk floor 13 and back part 11 of the rear seat 9 according to the illustration on FIG. 1. In the illustration on FIG. 4, the storage bag is to that effect folded once, so that this exterior 17 with the rough surface and anti-slip coating borders the underside of the trunk 12 as illustrated on FIG. 4, and the folded storage bag 2 lies on the trunk floor 13. This rough surface or anti-slip coating on the section of the exterior 17 thus makes it possible to securely keep cargo inside the trunk 13 when using the storage bag 2 as illustrated on FIG. 4, since the rough surface or anti-slip coating prevents the cargo from slipping on the exterior 17 of the storage bag 2. When used as illustrated on FIG. 4, the storage bag 2 is further attached to the remaining motor vehicle 1 by means of corresponding fastening devices 22, 23, 24, so that the storage bag 2 itself can also not engage in any slipping movements on the trunk floor 13.

Viewed as a whole, significant advantages are associated with the storage bag 2 according to the present disclosure and motor vehicle 1 according to the present disclosure. The bicycle 33 can be stored inside the accommodation space 18 of the storage bag 2 while being transported inside the trunk 12 of the motor vehicle 1. As a result, the bicycle 33 is not exposed to the environmental influences acting on the motor vehicle 1, and also does not negatively impact the aerodynamics of the motor vehicle 1. Due to the storage bag 2, the bicycle 33 is unable to damage or soil parts of the motor vehicle 1 bordering the trunk 12, since the bicycle 33 lies on these parts of the motor vehicle 1 indirectly by way of the bag 15. The storage bag 2 is further opaque and nontransparent, so that the fact that the bicycle 33 is being kept in the trunk 12 is not visible from outside. This provides additional protection against theft, especially in the case of expensive bicycles 33.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A storage bag for stowing a bicycle in a trunk of a motor vehicle comprising:
a bag defining an accommodation space, the bag having an opening for introducing and removing a bicycle into the accommodation space therethrough; and
at least one fastening device configured to attach the bag to the motor vehicle.

17. The storage bag according to claim 16, wherein the storage bag comprises at least one rear fastening device formed at a rear end area of the bag in the vicinity of the opening for attaching the bag to the motor vehicle and at least one front fastening device formed at a front end area of the bag for attaching the bag to the motor vehicle.

18. The storage bag according to claim 17, further comprising two rear fastening devices formed on the bag at two opposing rear end areas of the bag in the vicinity of the opening.

19. The storage bag according to claim 16, wherein the at least one fastening device each comprises a longitudinally adjustable element.

20. The storage bag according to claim 19, wherein the longitudinally adjustable element comprises an elastic band or elastic string.

21. The storage bag according to claim 19, wherein the at east one fastening device comprises a fastener to fix the fastening device on the motor vehicle.

22. The storage bag according to claim 21, wherein the fastener is selected from the group consisting of a hook, a hook and loop fastener, a suction cup, a pushbutton or a combination thereof to fix the fastening device on the motor vehicle.

23. The storage bag according to claim 21, wherein the fastener is provided at an end of the longitudinally adjustable element.

24. The storage bag according to claim 16, wherein the bag is at least partially made out of an opaque, flexible thin material.

25. The storage bag according to claim 24, wherein the bag is at partially made out of a plastic or fabric film.

26. The storage bag according to claim 16, wherein the bag comprises:
an interior side defining the accommodation space for the bicycle and having a smooth surface formed on at least a portion thereof; and
an exterior side having an anti-slip surface formed on at least a portion thereof.

27. The storage bag according to claim 16, wherein the length of the bag is in the range of 1.5 m to 2 m and the diameter of the bag is in the range of 0.5 m to 1 m.

28. The storage bag according to claim 16, wherein the bag comprises a first portion and a second portion at least partially detachable to the first portion to provide an additional opening.

29. The storage bag according to claim 30, wherein the bag further comprises a closure device for detachably fastening at least a part of the second portion to the first portion.

30. The storage bag according to claim 31, wherein the closure device comprises a bag zipper or a bag hook and loop fastener.

31. A motor vehicle comprising a vehicle body defining a trunk having an access opening into the vehicle, and a storage bag according to claim 16 disposed within the trunk.

32. The motor vehicle according to claim 33, wherein the storage bag is situated inside the trunk such that the opening of the storage bag is position in the access opening.

33. The motor vehicle according to claim 33, wherein the at least one fastening device of storage bag is attached to an attachment point in the vehicle body.

34. The motor vehicle according to claim 33, wherein the attachment point is selected from the group consisting of a front seat mounted in the vehicle body, a tailgate attached to the vehicle body, an eyelet on the vehicle body or a combination thereof.

35. The motor vehicle according to claim 33, further comprising a rear seat mounted in the vehicle body, the rear seat having a back part movable between a use position and a folded position so that the storage bag lies partially on the back part in the folded position.
